(19) United States
(12) Patent Application Publication
(10) Pub. No.: US 2018/0220185 A1
(43) Pub. Date: Aug. 2, 2018

(54) DEVICE AND METHOD FOR MODIFYING A STREAM OF ENCRYPTED MULTIMEDIA DATA

(71) Applicant: SAGEMCOM BROADBAND SAS, RUEIL MALMAISON (FR)

(72) Inventor: Gilles BARDOUX, RUEIL MALMAISON (FR)

(73) Assignee: SAGEMCOM BROADBAND SAS, RUEIL MALMAISON (FR)

(21) Appl. No.: 15/747,608

(22) PCT Filed: Jul. 25, 2016
(86) PCT No.: PCT/EP2016/067693

§ 371 Date: Jan. 25, 2018

(30) Foreign Application Priority Data
Jul. 29, 2015 (FR) 1557257

(51) Int. Cl. H04N 21/435; H04L 9/06; H04N 21/4627

(52) U.S. Cl. CPC H04N 21/4353; H04N 21/4627; H04L 9/065

(57) ABSTRACT

To modify a stream of encrypted multimedia data, a device connected to a control source and receiving said stream as an input performs the following steps: receiving a message coming from the control source, including information for identifying a separation of the incoming stream into at least one first substream and one second sub stream; deciphering the encrypted data of the first substream or substreams identified; modifying the encrypted data of the first substream or substreams identified, the modification being done using information received coming from the control source; encrypting the modified data of the first substream or substreams; and combining the first data substream or substreams, modified and encrypted, with the second substream, so as to obtain the stream of encrypted multimedia data sent as an output by the device.

The present invention relates to the field of the transmission of a multimedia data stream, more particularly the field of the modification of such multimedia data streams when they are protected by encryption.

Altering or modifying a multimedia data stream, corresponding for example to an audio, video or audiovisual signal, able to be broadcast over a device such as for example a television, is known. Conventionally, the functions of insetting a first programme in a second programme, better known by the English acronym “PIP”, (Picture in Picture), thus require modifying an audiovisual signal in order to embed therein another audiovisual signal in a specific area of the television screen.

The document US 2011/0265123 thus discloses a system for modifying a television programme, broadcast in the form of an audiovisual signal, by integrating therein a content coming from another source.

In the case of a digital audio and/or video signal, the signal takes the form of a stream of data packets (hereinafter “data stream”), the data encoding the audio and/or video signal. It is thus easy to extract the data transported by an incoming stream of data packets in order then to modify them before inserting them in an outgoing stream of data packets.

For a protected digital audio and/or video signal, that is to say wherein the data are protected by encryption, it is not possible to modify the data of the packet stream as taught in the document US 2011/0265123, the data being encrypted. One example of a protected digital audiovisual signal is defined for example in the HDMI (High-Definition Multimedia Interface) and HDCP (High-bandwidth Digital Content Protection) standards for connecting an audio/video source—such as a DVD (digital versatile disc) or Blu-ray reader, a computer or a games console—to a compatible device, such as a television set or video projector.

It can then be envisaged carrying out a deciphering of the data in order to be able to modify them, and then to encrypt the modified data, but these are data deciphering and encryption steps that consume a great deal of computing power, which requires either having a device offering greater computing power, which is therefore more expensive and complex to produce, or devoting more time in order to perform the deciphering and encryption operations, which introduces greater latency in the processing of the audiovisual signal, or a combination of these solutions.

The same problem is posed in modifying audio data or video data.

It is desirable to overcome these drawbacks of the prior art by providing a solution that allows modification of a stream of protected data by encryption by optimising the stream processing operations.

The present invention relates to a method for modifying a stream of encrypted multimedia data, the method being executed by a device receiving said stream as input and sending as an output a stream of encrypted multimedia data corresponding to the data of the incoming stream after modification, the device being connected to a control source; this method comprises the following steps: receiving a message coming from the control source, said message comprising information for identifying a separation of the incoming stream of encrypted multimedia data into at least one first substream of encrypted data and one second substream of encrypted data; deciphering the encrypted data of the first substream or substreams identified; modifying the encrypted data of the first substream or substreams identified, the modification being done using information received coming from the control source; encrypting the modified data of the first substream or substreams; and combining the first data substream or substreams, modified and encrypted, with the second substream, so as to obtain the stream of encrypted multimedia data sent as an output by the device.

Advantageously, this method therefore makes it possible to minimise the deciphering and encryption steps, these steps consuming computing time or power. This is because only a subpart of the incoming signal, corresponding to at least one first substream of encrypted data, is deciphered and then encrypted after modification, rather than the whole of the incoming signal. Thus the method makes it possible to reduce the computing power necessary for a device implementing the method, and therefore the consumption and/or cost price of the device, or, for an equal computing power, reducing the processing latency of the audio, video or audiovisual signal, or, more generally, any signal corresponding to a multimedia data stream.

In a complementary embodiment, the method for modifying a stream of encrypted multimedia data comprises a step, prior to the combining of the first substream or substreams of modified data with the second data substream, of placing data of the second substream in a buffer so that the first data substream or substreams, modified and encrypted, and the second substream are synchronised.

Advantageously, in order to compensate for the processing time of the first data substreams, the second substream is placed in a buffer. Thus the step of recombining the substreams can be performed on easily synchronised substreams.

In a particular embodiment of the method for modifying a stream of encrypted multimedia data, the multimedia data of the incoming stream are encrypted by a first encryption function, the encryption of the modified data of the first data substream or substreams is carried out by a second encryption function, and the method comprises a step, prior to the combining of the first substream or substreams of modified data and the second substream, of transencryption of the data of the second substream from the first encryption function to the second encryption function, the data of the stream sent by the device being therefore encrypted by the second encryption function.

Advantageously, the method is compatible with a function of transencryption of the incoming data stream from a first encryption function to a second encryption function, the advantage of completely encrypting only the first data substream or substreams being kept.

In a complementary embodiment of the method for modifying a stream of encrypted multimedia data, the encrypted data of the incoming stream are encrypted by means of a homomorphic function and the method further comprises the following steps before deciphering the first substream or substreams identified: also receiving coming from the control source a data stream corresponding to information on global modification to be made on the data of the incoming stream, encrypting these data by means of the homomorphic function and carrying out a linear combination between the stream of previously encrypted data corresponding to global modification information and the incoming stream of multimedia data, this linear combination of streams becoming the incoming stream for carrying out subsequent steps of the method.

Advantageously, it is thus possible to make modifications to the incoming data stream without having to perform a deciphering step. Thus, if other modifications that cannot be carried out in this same previous modification operation are to be performed on a particular data substream, only this data substream requires to be deciphered before modification rather than the whole of the data stream.

In another complementary embodiment of the method for modifying a stream of encrypted multimedia data, the encryption of the modified data of the first substream or substreams is carried out by means of a homomorphic function, and the method comprises the following steps prior to the combining of the first substream or substreams of modified and encrypted data with the second substream of transencrypted data:

receiving from the control source a data stream corresponding to information on a global modification to be made to the data of the incoming stream,

encrypting these data by means of the homomorphic function, and

making a linear combination between the stream of previously encrypted data corresponding to global modification information and the first substream or substreams of modified and encrypted data, or respectively and alternatively the second substream of transencrypted data, this linear combination of streams becoming the first substream or substreams of modified and encrypted data, or respectively and alternatively the second substream of transencrypted data, for making the subsequent combination constituting the stream of encrypted multimedia data sent as an output by the device 100.

Advantageously, and in a similar manner to the previous embodiment, this embodiment makes it possible to make modifications to the data stream without having to perform a deciphering step. Thus, if other modifications that cannot be carried out in this same previous modification operation are to be performed on a particular data substream, only this data substream requires to be deciphered before modification rather than the whole of the data stream.

The present invention also relates to a device comprising means for receiving an incoming stream of encrypted multimedia data and sending an outgoing stream of encrypted multimedia data, the data in the outgoing stream corresponding to the data in the incoming stream after modification, the device comprising means for receiving a message coming from a control source, said message comprising information for identifying a separation of the incoming stream of encrypted multimedia data into at least one first encrypted data substream and one second encrypted data substream, means for deciphering the encrypted data of the first substream or substreams identified, means for modifying the deciphered data of the first substream or substreams identified, the modification being done using information received coming from the control source, means for encrypting the modified data of the first substream or substreams, and means for combining the first substream or substreams of modified and encrypted data with the second substream, so as to obtain the stream of encrypted multimedia data sent as an output by the device.

The present invention also relates to a computer program that can be stored on a medium and/or downloaded from a communication network, in order to be read and executed by a processor. This computer program comprises instructions for implementing the method mentioned above according to any of the variants thereof. The invention also relates to storage means comprising such a computer program.

The features of the invention mentioned above, as well as others, will emerge more clearly from the reading of the following description of an example embodiment, said description being given in relation to the accompanying drawings, among which:

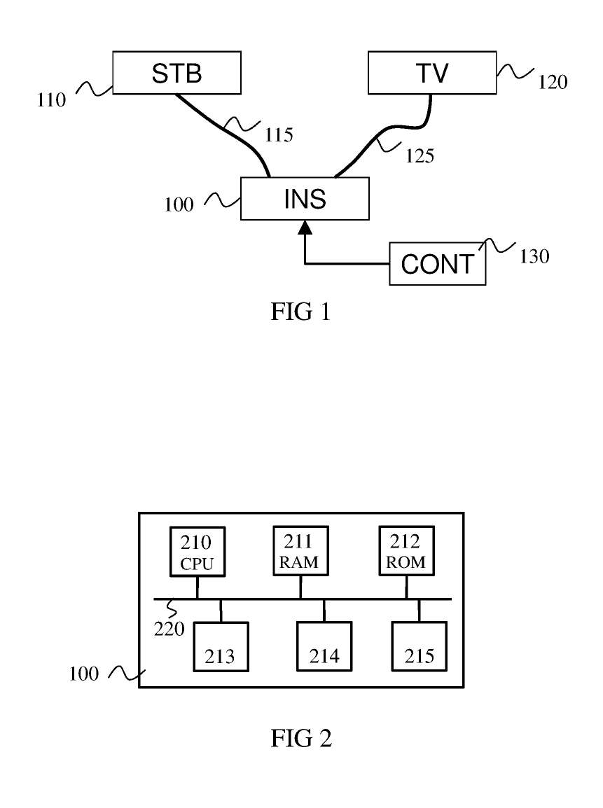

FIG. 1 illustrates schematically a system comprising a device executing a method for modifying a stream of encrypted multimedia data according to one of the embodiments,

FIG. 2 illustrates schematically an example of hardware architecture of a device executing a method according to one of the embodiments of the present invention,

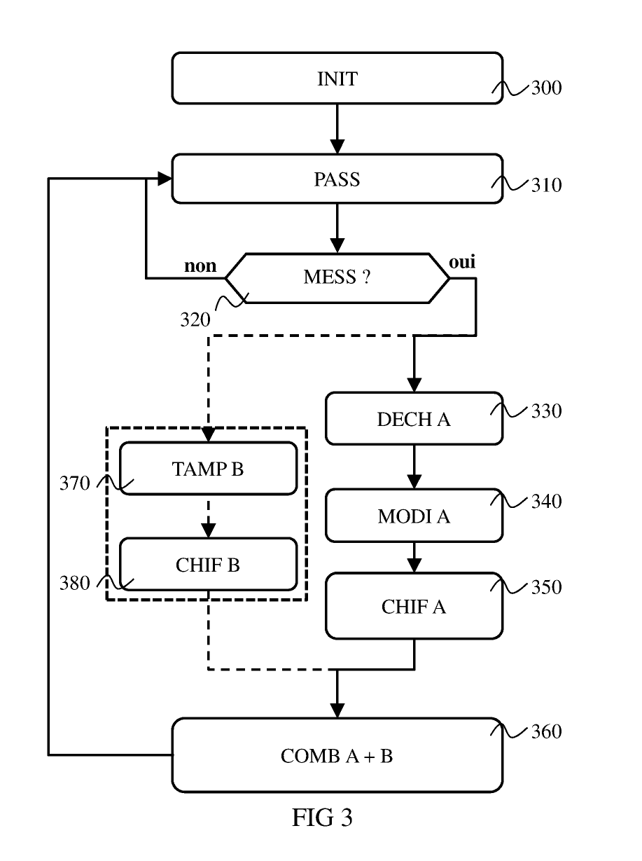

FIG. 3 illustrates schematically a flow diagram describing an embodiment of the method for modifying a stream of encrypted multimedia data,

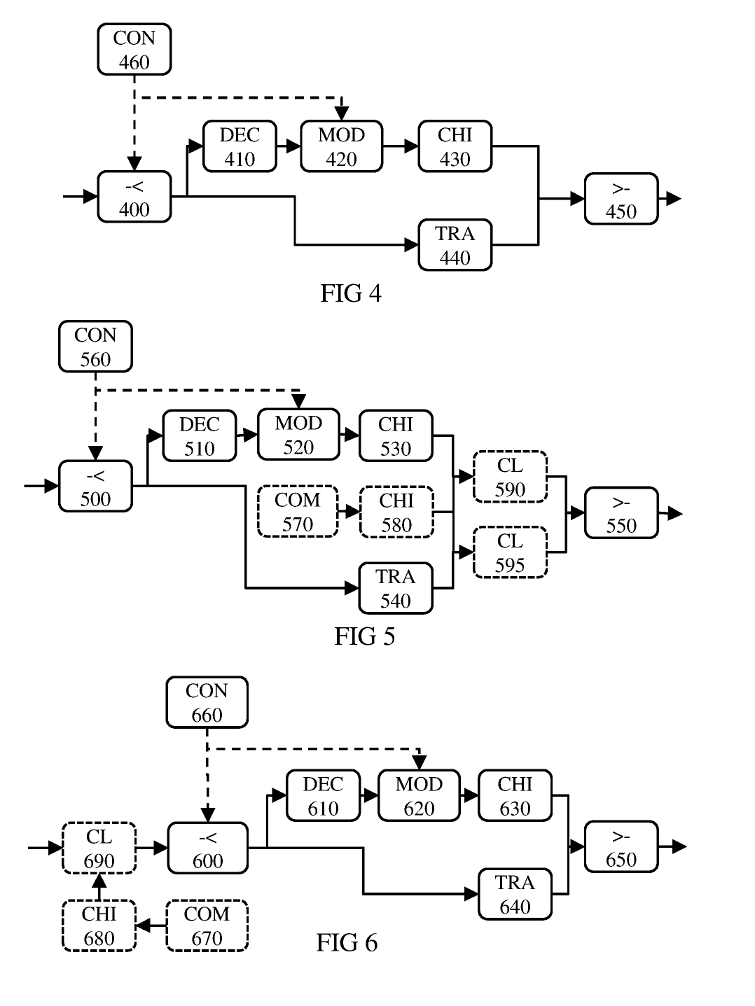

FIG. 4 illustrates schematically an example of modular breakdown of at least part of a device executing a method for modifying a stream of encrypted multimedia data according to a first embodiment,

FIG. 5 illustrates schematically an example of modular breakdown of at least part of a device executing a method for modifying a stream of encrypted multimedia data according to a second embodiment, and,

FIG. 6 illustrates schematically an example of modular breakdown of at least part of a device executing a method for modifying a stream of encrypted multimedia data according to a third embodiment.

FIG. 1 illustrates schematically a system in which the present invention can be implemented.

The system in FIG. 1 comprises a device 100, executing the method for modifying a stream of encrypted data, the device 100 being connected to a first device 110, for example a DVD (digital versatile disc) or Blu-ray reader, a computer, a games console or a TV decoder (STB; set-top box), and a second device 120, typically a television set or a video projector.

More generally, the first device 110 may be any device sending a stream of encrypted multimedia data.

Likewise, the second device 120 may be any device able to receive a stream of encrypted multimedia data, whether for example in order to restore them (display on a screen, etc.), or to record them or to transmit them to one or more other devices. According to a particular embodiment, a plurality of devices 120 may be connected to the device 100 and thus each receive a stream sent as an output by the device 100. The streams sent as an output may be identical for all the devices 120 or on the contrary be specific to the various devices 120 for which said streams are respectively intended.

According to a complementary embodiment, the device 100 uses a broadcast technology for sending the data stream as an output, a plurality of devices 120 then being able to receive the stream sent simultaneously.

Conventionally, the two devices 110 and 120 would be directly connected to each other, and the device 100 is therefore interposed in the link or connection between the two devices 110 and 120.

The connection between the various devices can be achieved via a connection in accordance with the HDMI (High-Definition Multimedia Interface) standard, which defines a normal standard for passing multimedia streams (corresponding for example to audio, video or audiovisual signals), which can be encrypted by an anti-copying locking technology or function known as HDCP (High-bandwidth Digital Content Protection).

In FIG. 1, the connections 115 and 125 between the various devices are made with so-called HDMI cables.

According to other embodiments of the present invention, the connection between two devices can be made via other technologies, for example so-called wireless technologies of the WiDi (Wireless Display) type; likewise the type of connection between the device 110 and the device 100 may be different from the type of connection between the device 100 and the device 120. An example of the latter embodiment is the use of different versions of the HDMI standard for the connections 115 and 125.

The device 100 is also connected to a control source 130. Connection means that the device 100 and the control source 130 can exchange messages. The device 100 can also receive, from the control source, messages comprising commands or instructions, information, etc.

The device 100 and the control source 130 can thus be directly connected to each other via cabling or a direct wireless connection. They may also be connected to the same network, for example of the IP (Internet protocol) type, whether via interfaces of the Ethernet or Wi-Fi (Wireless Fidelity) type, or other.

According to another embodiment, the control source 130 is integrated in the device 100.

The device 100 is suitable for receiving as an input a stream of encrypted multimedia data, coming from the device 110, and sending a stream of encrypted multimedia data as an output, to the device 120, the stream of encrypted multimedia data sent to the device 120 corresponding to the stream of data received coming from the device 110 and modified using information received coming from the control source 130.

The method described in the present document therefore enables the device 100 to receive and then modify the stream of encrypted multimedia data coming from the device 110 in order then to send the results of the modification, still encrypted, to the device 120.

The data stream received by the device 100 is modified according to information received from the control source 130. In particular, as described in more detail below, the control source 130 supplies to the device 100 information making it possible:

to identify a separation in the incoming stream of encrypted multimedia data, the separation making it possible to divide the incoming stream into at least one first substream of encrypted data and a second substream of encrypted data, and

to modify the data of the first identified substream or substreams, the modification therefore taking place using information received coming from the control source 130.

The information coming from the control source 130 making it possible to identify a separation of the incoming stream into substreams makes it possible to identify at least one first substream of encrypted data, the second substream being identified by complementarity. In other words, the identification information makes it possible to separate one or more first substreams, the rest of the incoming substreams constituting the second substream. In this case, the identification information makes it possible to identify the part or parts of the incoming stream that are modified in the subsequent steps of the method, that is to say the first substream or substreams.

Modification means here a modification of the content of the incoming stream of encrypted multimedia data, that is to say a modification or alteration of the multimedia data. In other words, this means a modification of the medium or media encoded and transported in the data stream. The multimedia data stream may correspond to an audio and/or video signal, for example an audiovisual signal. Modification then means modifying one or more audio or video components of the signal. More simply, it can be said that the audiovisual signal corresponding to the incoming data stream is different from the audiovisual signal corresponding to the outgoing data stream after modification.

It should thus be noted that an operation of transencryption of a content, an operation that consists of using a content encrypted by a first encryption function for obtaining the same content encrypted by a second encryption function, is therefore not a modification within the meaning of the present document, the content itself not being modified during the operation.

According to an alternative embodiment, the identification information makes it possible to identify a second substream, the rest of the incoming stream constituting a first substream. In this case, the identification information identifies the part of the incoming stream that is not modified in the subsequent steps of the method, that is to say the second substream.

The first substream or substreams correspond for example to:

one or more audio channels of the audiovisual signal entering the device 100, and/or

one or more zones of the image of the video component of the audiovisual signal entering the device 100.

More generally, the first substream or substreams correspond for example to one or more spatiotemporal zones of an audiovisual signal corresponding to a multimedia content, that is to say a content that may comprise one or more videos (video component or components), one or more sounds (audio component or components), texts, etc.

For a video part or component of an audiovisual signal, the term “spatiotemporal zone” designates a part of an image at a given instant.

For an audio part or component of an audiovisual signal, which may comprise a plurality of audio channels, the term “spatiotemporal zone” designates a sound sample at a given instant for a given audio channel.

The information received from the control source 130 and making it possible to modify the data of the first substream or substreams may be of various natures.

In the case of first substreams of the audio stream type, the information may be an audio signal intended to be added to the first audio substreams, or even intended to replace them. Mention can be made for example of an audio signal of the “alarm siren” type intended to be added to at least one audio channel of the incoming stream.

In the case of first substreams of the video stream type, the information may correspond to a video signal coming from a surveillance camera or a webcam.

In the case of the first substreams of the text type, for example corresponding to subtitle or programme data, the information may correspond to a replacement text.

According to the embodiment illustrated in FIG. 1, the connections 115 and 125 being in accordance with the HDMI standard, the data streams are in accordance with the formats recommended by this HDMI standard. The format of the video component of the multimedia data stream may for example be in accordance with the HDTV (High Definition Television) 1080p encoding standard and the format of the audio component in accordance with an encoding standard of the PCM (pulse code modulation) type.

FIG. 2 illustrates schematically an example of hardware architecture of the device 100. The device 100 then comprises, connected by a communication bus 220: a processor or CPU (central processing unit) 210; a random access memory (RAM) 211; a read only memory (ROM) 212; a storage unit or a storage medium reader such as a an SD (secure digital) card reader or an HDD (hard disk drive) (not shown); and a set of interfaces 213, 214 and 215 for respectively connecting the device 110, the device 120 and the control source 130. The interface 213 (referred to as “input interface”) can thus receive a stream of encrypted multimedia data coming from the device 110, the interface 214 (referred to as the “output interface”) can thus send to the device 120 a stream of modified and encrypted multimedia data, and the interface 215 (referred to as the “control interface”) can receive, coming from the control source 130, messages comprising information of various types.

The processor 210 is capable of executing instructions loaded into the RAM 211 from the ROM 212, from a memory or storage medium, internal or external (not shown), or from a communication network. When the device 100 is powered up, the processor 210 is capable of reading instructions in the RAM 211 and executing them. These instructions form a computer program allowing the implementation or execution, by the processor 210, of all or some of the modules, algorithms and steps described in the present document.

Thus all or some of the modules, algorithms and steps described in the present document can be implemented in software form by the execution of a set of instructions by a programmable machine, such as a DSP (digital signal processor) or a microcontroller. All or some of the modules, algorithms and steps described below can also be implemented in hardware form by a machine or a dedicated component, such as an FPGA (field-programmable gate array) or an ASIC (application-specific integrated circuit).

FIG. 3 illustrates schematically a flow diagram describing an embodiment of the method for the modification, by the device 100, of a stream of encrypted multimedia data coming from the device 110.

A first step or phase 300 of initialisation of the device 100 is executed when for example the device 100 is powered up or following a request for reinitialisation of the device 100. This first step is typically performed when the device 100 is inserted between the devices 110 and 120. For example, starting from a situation where the devices 110 and 120 are directly connected via a cable 115 (situation not shown), the end of the cable 115 connected to the device 120 is disconnected from this device 120 and then connected to the device 100, on the so-called input interface. A new cable 125 is connected to the device 100, on the output interface, and to the device 120, in order to obtain the final configuration illustrated in FIG. 1. The device 100 can be supplied electrically via one of the cables 115 or 125, have an internal supply source (battery), or be supplied by an external electrical supply source.

The initialisation phase 300 may comprise a phase of analysis of the incoming audio, video or audiovisual signal, that is to say of the stream of encrypted multimedia data coming from the device 110. This analysis phase may comprise a phase of recovery, from a source, not shown in FIG. 1, of a deciphering key associated with the incoming data stream.

The initialisation phase 300 may also comprise a step of detection, initialisation or configuration of a connection with the control source 130. This configuration may be done automatically, or manually by a user of the system. According to one embodiment, a configuration menu may for example be displayed by the device 100 on the device 120.

In a following phase 310, and failing reception of the message coming from the control source 130, the device 100 may behave in a so-called “transfer” mode (pass-through mode), that is to say the stream sent by the device 100 as an output corresponds to the incoming stream received coming from the device 110. In this mode, no modification is made to the content of the stream of encrypted multimedia data by the device 100.

In a following step 320, the device 100 receives a message coming from the control source 130, the message comprising information making it possible to identify a separation of the incoming stream of encrypted multimedia data into at least one first substream of encrypted data and a second substream of encrypted data. In other words, the device 100 receives from the control source 130 a message informing it that a subpart of the incoming audiovisual signal is to be modified. The subpart of the signal corresponding to the first data substream or substreams is identified for separation. In concrete terms, the separation of the incoming stream makes it possible to distinguish between a first part of the incoming audiovisual signal that is to be modified by the device 100 and another part that is not to be modified. The first part of the audiovisual signal that is to be modified corresponds to the first substream or substreams, and the first data substream or substreams are therefore identified for separation.

It should be noted that, in the absence of a message received coming from the control source 130, the device 100 remains in the state 310, that is to say the audiovisual signal or data stream coming from the device 110 is transmitted as it stands to the device 120.

In a step 330, a message coming from the control source 130 having been received, the message comprising information making it possible to identify a separation of the incoming stream of encrypted multimedia data into at least one first encrypted data substream and a second encrypted data substream, the device deciphers the encrypted data of the first substream or substreams identified. In other words, during this step 330, the device deciphers the data of the incoming stream that correspond to the data of the incoming stream to be modified, and only these data. Thus not the entire incoming stream is deciphered, which is a saving in terms of computing time or computing power necessary. It should be noted that, depending on the nature of the encryption used for encrypting the data of the incoming stream, the device 100 may despite everything have to decipher some of the data contained in the second data substream to allow the deciphering of data of the first substream or substreams. This may be the case for a data encryption functioning by data block encryption, where a data block may require information coming from a previous block in order to be deciphered. The characteristics of the encryption may give rise to various constraints. Thus, for example, if the encryption is of the “AES CBC” (Advanced Encryption Standard, Cipher Block Chaining) type, it is necessary, during the deciphering step 330, to know the encrypted data corresponding to the block preceding the data block which it is wished to decipher in order to be able to decipher this block.

Following this step 330, the data of the first substream or substreams are no longer encrypted.

In a following step 340, the device 100 modifies the data of the first substream or substreams identified, the modification taking place using information received coming from the control source 130. The modification or modifications may consist of a replacement of the data of the first substream or substreams with data received coming from the control source 130. The information received coming from the control source 130 then take the form of one or more data streams. The device 100 may thus allow an insetting of an audiovisual signal coming from the control source in an audiovisual signal coming from the device 110 (PIP; Picture In Picture), the insetting taking place in a specific zone defined by the information included in the message received during step 320.

The modification or modifications may be a superimposition of audiovisual signals, that is to say, in a combination of data streams, a combination between the first data substream or substreams and a data stream coming from the control source 130. Persons skilled in the art know how to combine a plurality of data streams, that is to say to make a combination of a plurality of audiovisual signals, in order to constitute a signal superimposing the plurality of audiovisual signals, that is to say combining the plurality of data streams. “Combination” means here any function or transformation taking as arguments the data streams deciphered during step 330 and the information received coming from the control source 130, and resulting in a data stream, referred to as the combined data stream.

The modification may consist of a modification of the data streams, the modification taking place using information received coming from the control source 130. It may be a modification of an image (increase in contrast, conversion from colour to black and white, etc.) and/or of the sound (addition of a sound—such as a siren, application of sound effects—equaliser for example).

In a subsequent step 350, each first data substream previously modified is encrypted. As discussed further on in this document, the encryption may done using the same encryption function—and the same encryption parameters—as the encryption protecting the incoming data stream received by the device 100, or may be done using a separate encryption function. In the latter case, and only in the latter case, a supplementary step 380 is necessary to adapt the encryption of the second substream (transencryption step), step 380 described below.

Steps 320, 330, 340 and 350 make it possible respectively to identify, separate and modify one or more first substreams, and in the end to be obtain respectively one or first modified and encrypted data substreams.

In parallel to these steps 320, 330, 340 and 350, step 370, and optionally step 380, relate to the second data substream. Step 370 is a placing of the data of the second substream in a buffer so that the first data substream or substreams, modified and encrypted, and the second data substream are synchronised, with a view to the recombination of the first substream or substreams with the second substream in a step 360 described below. In the case where the encryption of the first substream or substreams carried out during step 350 is an encryption identical to the encryption used for the incoming stream received by the device 100 (that is to say identical to the encryption of the outgoing data stream of the device 110), then the placing of the second data substream in the buffer compensates for the time taken for processing the first substream or substreams during steps 330, 340 and 350. In other words, if the encryption function used during step 350 and the encryption function used for encrypting the data stream received by the device 100 are the same, there is no need for the step 380 of transencryption of the second substream.

On the other hand, should the encryption of the first substream or substreams carried out during step 350 be an encryption different from the encryption used for the incoming stream received by the device 100, then it is necessary to proceed with step 380 of transencryption of the second data substream, so that the first modified and encrypted data substream or substreams and the second data substream have identical encryption.

In other words, let “f” be the encryption function for obtaining the encrypted data stream output from the device 110, that is to say the incoming data stream received by the device 100, and let “g” be the encryption function used during step 350, then, if “f” is equal to “g”, there is no step 380 of transencryption of the second substream.

Conversely, if the function “f” is different from the function “g”, then a transencryption by a function “t” of the second substream is carried out during step 380, with:

t=g^{o}f⁻¹

Thus an operation of transencryption of an encryption function “f” to an encryption function “g” corresponds to the execution of a single function “t”. A transencryption carried out in a single step by a function “t” is therefore generally less consuming in terms of computing time or computing power than a first deciphering step (by a function “f⁻¹”) followed by a second encryption step (by the function “g”), which is particularly advantageous.

In the case where the transencryption step 380 is necessary, the time taken for the placing of the data of the second substream in a buffer carried out during step 370 is adapted in order to include the time taken for processing the transencryption of the second substream, that is to say the duration of step 380. In other words, the time taken for the placing of the second substream in a buffer carried out during step 370 in the case where the functions “f” and “g” are different is equal to the time taken for placing in a buffer in the case where the functions “f” and “g” are equal, reduced by the time for transencryption of the second data substream, that is to say the time for performing step 380. Time for the placing of data in the buffer means the time for maintaining the data in the buffer; that is to say the time that elapses between the moment when the data are placed in the buffer and the moment when the data are extracted from the buffer in order to perform a subsequent step.

In other words, if the multimedia data of the incoming stream are encrypted by a first encryption function, corresponding to an encryption function “f” and the encryption of the modified data of the first substream or substreams is done by a second encryption function, corresponding to an encryption function “g”, different from the function “f”, then the method comprises a transencryption step 380, prior to the combining of the first modified data substream or substreams and the second substream (step 360, see below). The transencryption executed during step 380 consists of a transencryption of the data of the second substream from the first encryption function (“f”) to the second encryption function (“g”). The data of the stream sent by the device 100 are therefore encrypted by the second encryption function, that is the say the encryption corresponding to the function “g”.

It should be noted that, depending on the embodiment, steps 370 and 380 may be carried out indifferently either in the order described in this document or in another order, the transencryption step 380 being performed for example before the placing in buffer of step 370. According to an alternative embodiment, the duration of processing of step 380 may be adapted in order to correspond to the total processing duration of steps 320, 330, 340 and 350. In this case, step 370 of placing in buffer becomes unnecessary.

Finally, in step 360, the device 100 combines the first modified and encrypted data substream or substreams, as obtained at the end of step 350, with the second substream, delayed during step 370 and optionally transencrypted during step 380, so as to obtain a so-called combined stream. This combined stream, issuing from step 360, constitutes the stream of encrypted multimedia data sent as an output by the device 100. The data stream issuing from step 360 therefore corresponds to an encrypted data stream, the encryption having been carried out by the function “g”. This data stream issuing from step 360 is the data stream sent as an output from the device 100. These data of the outgoing stream from the device 100 correspond to the data of the stream entering the device 100 after modification of certain data in the stream during step 340. The modification or modifications were carried out without the whole of the incoming data stream having been deciphered. In the end, the computing time or computing power necessary for implementing the present method is less than the computing time or computing power necessary for implementing the method implementing a technical solution where the whole of the incoming stream must be deciphered in order to be able to perform the modification or modifications.

FIG. 4 illustrates schematically an example of modular division of at least part of a device 100 executing a method for modifying a stream of encrypted multimedia data according to a first embodiment of the method illustrated in FIG. 3.

A module 400 receives as an input the stream of encrypted multimedia data sent by the device 110, as well as messages from the control source 130 (represented here by a module 460). The module 400, according to messages received from the control source 130, performs step 320 by proceeding with the separation of the incoming stream into one or more first substreams and a second substream (symbol “-<” in FIGS. 4, 5 and 6). Separation may mean a physical separation of electrical signals corresponding to the incoming stream, a physical separation of the data of the incoming stream, the data of the first substream or substreams and of the second substream being directed to different modules, or a virtual separation of the first substream or substreams and of the second substream, the separation then occurring at a logic level.

A module 410 performs the deciphering (abbreviation “DEC” in FIGS. 4, 5 and 6) of the first data substream or substreams, as described during step 330.

A module 420 performs the modification or modifications (abbreviation “MOD” in FIGS. 4, 5 and 6) of the first data substream or substreams, as described during step 340.

A module 430 performs the encryption (abbreviation “CHI” in FIGS. 4, 5 and 6) of the first data substream or substreams, as described during step 350.

A module 440 effects the placing in buffer, and optionally the transencryption, of the second substream, as described during steps 370 and 380 (abbreviation “TRA” in FIGS. 4, 5 and 6).

A module 450 effects the combination of the first data substream or substreams, modified and encrypted, and of the second data substream, optionally transencrypted, as described during step 360 (symbol “ [symbol] ” in FIGS. 4, 5 and 6).

The input interface of the device 100, connected to the device 110, corresponds to the module 400, and the output interface, connected to the device 120, corresponds to the module 450.

The module 460 corresponds here to the control source 130 (abbreviation “CON” in FIGS. 4, 5 and 6), this control source 130 here being represented as a module internal to the device 100. According to another embodiment, the control source 130 is a module external to the device 100.

FIGS. 5 and 6 described below correspond to complementary embodiments of the invention. These embodiments are characterised by the homomorphic character either of the encryption function used for encrypting the stream entering the device 100, or of the encryption function used during the encryption step 350, or of these two encryption functions. In these complementary embodiments, because of the homomorphic character of at least one of the two encryption functions, changes may be made to the multimedia data stream or certain multimedia data substreams in the so-called form of “additions”. As will be seen below, a change or addition is to be distinguished from a modification made during step 340 for at least these reasons:

the application of an addition requires an encryption function to be homomorphic, and

the application of an addition does not require deciphering the data stream during a step 330.

It should be noted that any change or addition to be applied to the multimedia data stream or to certain substreams could be made via a modification step 340. This modification step 340 on the other hand requires a prior deciphering step 330. Conversely, it is not always possible to modify the multimedia data stream, or certain substreams, via the application of an addition. This is the case if no encryption function used is homomorphic, but also according the nature of the modifications to be made. Thus certain modifications require, to be effected, that the multimedia data to be modified be previously deciphered and cannot therefore be performed via the application of an addition.

FIG. 5 illustrates schematically an example of modular division of at least part of a device executing a method for modifying a stream of encrypted multimedia data according to a second embodiment, this embodiment being characterised by the homomorphic character of the encryption function “g”, the encryption function used during step 350.

The modules 500, 510, 520, 530, 540, 550 and 560 correspond respectively to the previously described modules 400, 410, 420, 430, 440, 450 and 460 with similar functions.

The modules 570, 580, 590 and 595 are particular to this second embodiment characterised by the homomorphic character of the encryption function “g”.

If “S” represents an audiovisual signal and “C” represents an audiovisual addition to be made to the signal “S”, the application of the addition C to the signal S is denoted “C×S”, and, because of the homomorphic character of the encryption function “g”, this gives:

g(C×S)=g(C)×g(S);

This property of homomorphism of “g” is used in the modules 570, 580, 590 and 595.

The module 570 corresponds to the acquisition of the audiovisual addition “C” (abbreviation “COM” in FIGS. 5 and 6), this addition “C” being able to come for example from the control source 130 (here the control module 560). It may for example be an audio alarm signal intended to be added to the audiovisual signal sent by the device 110.

The module 580 takes this addition “C” as an input and applies the encryption function “g” to this addition. In other words, the module 580 encrypts “C” using the encryption function “g”.

Because of the homomorphic character of the function “g”, it is then possible to linearly combine the result obtained at the output of the module 580 with the result obtained at the output of the module 530 (audiovisual signal corresponding to the encryption by “g” of the modified data of the first substream or substreams) or of the module 540 (audiovisual signal corresponding to the transencryption and placing in buffer of the data of the second substream). These combinations are respectively executed by the modules 590 and 595 (abbreviation “CL” in FIGS. 5 and 6).

The module 550 then takes as an input either the result of the modules 590 and 540, or the result of the modules 595 and 530, or the result of the modules 590 and 595, these results being combined at the output of the module 550 in order to form the stream of modified and encrypted data from the device 100.

In the first case, the addition “C” is applied only to the first substream or sub streams.

In the second case, the addition “C” is applied only to the second substream.

In the third case, the addition “C” is applied to the first and second substreams.

It should be noted that, in the second and third cases, the second substream is de facto modified by the application of an addition. However, this modification is not performed by the module 520 and has therefore not necessitated the deciphering of the second substream.

In other words, according to the second embodiment characterised by the homomorphic character of the encryption function “g”, the device 100 is suitable for performing the following steps, prior to the combining of the first substream or substreams of data, modified and encrypted, with the second substream of transencrypted data:

receiving, coming from the control source 130, a data stream corresponding to information on global modification to be made to the data of the incoming stream (module 570),

encrypting these data by means of the homomorphic function “g” (module 580), and

effecting a linear combination between the stream of previously encrypted data corresponding to global-modification information and the first data substream or substreams, modified and encrypted (module 590), or respectively and alternatively the second substream of transencrypted data (module 595), this linear combination of streams becoming the first substream or substreams of data, modified and encrypted, or respectively and alternatively the second substream of transencrypted data, for effecting the subsequent combination constituting the stream of encrypted multimedia data sent as an output by the device (combination made by the module 550).

According to a supplementary embodiment of the invention, it is possible to apply a first addition to the first substream and a second addition to the second substream, the first and second additions being able to be different. In this case, the acquisition module 570 may receive the first and second additions from the control source 130. Alternatively, two different control sources 130 may be connected to the acquisition module 570 and each respectively supply the first and second addition. It is also possible, according to one embodiment, to have at least two acquisition modules 570 and two encryption modules 580, each first and second addition intended respectively for the first and second substreams being processed by an acquisition module 570 and an encryption module 580 that are distinct from each other.

FIG. 6 illustrates schematically an example of a modular division of at least part of a device executing a method for modifying a stream of encrypted multimedia data according to a third embodiment, this embodiment being characterised by the homomorphic character of the encryption function “f”, an encryption function making it possible to obtain the stream of encrypted data at the output of the device 110, that is to say an encryption function used for encrypting the incoming data stream received by the device 100.

The modules 600, 610, 620, 630, 640, 650 and 660 correspond respectively to the previously described modules 400, 410, 420, 430, 440, 450 and 460 with similar functions.

The modules 670, 680 and 690 are particular to this third embodiment characterised by the homomorphic character of the encryption function “f”.

This property of homomorphism of “f” is used in the modules 670, 680 and 690.

The module 670 corresponds to the acquisition of the audiovisual addition “C”, this addition “C” being able to come from the control source 130 (here the control module 660). It is for example an audio alarm signal intended to be added to the audiovisual signal sent by the device 110.

The module 680 takes this addition “C” as an input and applies the encryption function “g” to this addition. In other words, the module 680 encrypts “C” using the encryption function “f”.

Because of the homomorphic character of the function “f”, it is then possible to linearly combine the result obtained at the output of the module 680 directly with the incoming encrypted data stream of the device 100.

The module 600 then takes as an input the result of this linear combination, which makes it possible to apply the addition to the whole of the audiovisual signal entering the device 100.

In other words, according to this third embodiment characterised by the homomorphic character of the encryption function “f”, the device 100 is suitable for performing the following steps, performed prior to the deciphering of the first substream or substreams identified:

receiving from the control source 130 a data stream corresponding to information on global modification to be made to the data of the incoming stream,

encrypting these data by means of the homomorphic function “f”, and

effecting a linear combination between the stream of previously encrypted data corresponding to global-modification information and the incoming encrypted multimedia data stream, this linear combination of streams becoming the incoming stream for performing the following steps of the method, that is to say the output of the linear combination module 690 is the input of the module 600 corresponding to the module 400 in FIG. 4.

In general terms, applying an addition, using the homomorphic character of an encryption function, is less consuming in terms of computing time or computing power than effecting a modification as described in step 340 (via a module 420, 520 or 620) since said modification requires a prior deciphering step 330 (via a module 410, 510 or 610) and a subsequent encryption step 350 (via a module 430, 530 or 630). T he deciphering and encryption operations (steps 330 and 350) are operations that are demanding in terms of computing power or time.

According to a supplementary embodiment of the invention, the control source 130 (module 460, 560 or 660) may include a control signal making it possible to distinguish, when modifications are to be made to one or more data substreams, between the modifications that must be performed via a modification step 340 and those that may be performed in the form of an addition. Thus, advantageously, the computing time or power necessary is reduced compared with a solution using only a single step or modification of the multimedia data substream or substreams such as step 340. The control source, receiving a request for change to be made to a multimedia data substream, can thus decide to apply this change in the form of an addition (via the modules 570, 580 and 590/595, or 670, 680 and 690) rather than a modification (via a module 520 or 620) in order to save on computing time or power. The control source takes the decision to make a change according to one or other of the methods depending on the nature of the changes to be made to the multimedia data stream. If several modifications are to be made, the control source 130 can thus distinguish between a first group of modifications to be made via a step 340 (via a module 520 or 620) and a second group of modifications to be made via the application of an addition (via the modules 570, 580 and 590/595, or 670, 680 and 690). The control source 130 can thus divide a modification to be made to a multimedia data substream into a part of the modification to be made via a step 340 (via a module 520 or 620) and another part of the modification to be made via the application of an addition (via the modules 570, 580 and 590/595, or 670, 680 and 690). The control source 130 (the module 460, 560 or 660) can thus send messages comprising the information on modifications corresponding to the modifications or additions to be made to the modules 520 or 620 (for the modifications) or the modules 570 or 670 (for the additions).

The present description of the method, and of the device implementing the method, for modifying a stream of encrypted multimedia data has proposed the application thereof in the case where the multimedia data stream corresponds to an audiovisual signal. The same principle can just as well be implemented in the case where the multimedia data stream corresponds to one or more audio signals, to one or more video signals, to media of the text type, or to any combination of the aforementioned cases.

1. A method for modifying a stream of encrypted multimedia data, the method being executed by a device receiving said stream as input and sending as an output a stream of encrypted multimedia data corresponding to the data of the incoming stream after modification, the device being connected to a control source, wherein the method comprises the following steps:
receiving a message coming from the control source, said message comprising information for identifying a separation of the incoming stream of encrypted multimedia data into at least one first substream of encrypted data and one second substream of encrypted data;
deciphering the encrypted data of the first substream or substreams identified;
modifying the encrypted data of the first substream or substreams identified, the modification being done using information received coming from the control source;
encrypting the modified data of the first substream or substreams; and
- combining the first data substream or substreams, modified and encrypted, with the second substream, so as to obtain the stream of encrypted multimedia data sent as an output by the device.

2. The method according to claim 1, further comprising a step, prior to the combining of the first modified data substream or substreams with the second data substream, of placing in a buffer data of the second substream so that the first modified and encrypted data substream or substreams and the second substream are synchronised.

3. The method according to claim 1, wherein the multimedia data of the incoming stream are encrypted by a first encryption function, the encryption of the modified data of the first substream or substreams is effected by a second encryption function, and wherein the method comprises a step, prior to the combining of the first substream or substreams of modified data and the second data substream, of transencryption of the data of the second substream from the first encryption function to the second encryption function, the data of the stream sent by the device therefore being encrypted by the second encryption function.

4. The method according to claim 1, wherein the encrypted data of the incoming stream are encrypted by means of a homomorphic function, the method further comprising the following steps before deciphering the first substream or substreams identified:
further receiving from the control source a data stream corresponding to information on global modification to be made to the data of the incoming stream,
encrypting these data by means of the homomorphic function,
carrying out a linear combination between the stream of previously encrypted data corresponding to global modification information and the incoming stream of encrypted multimedia data, this linear combination of streams becoming the incoming stream for performing the subsequent steps of the method.

5. The method according to claim 3, wherein the encryption of the modified data of the first substream or substreams is carried out by means of a homomorphic function, the method comprising the following steps prior to the combining of the first substream or substreams of modified and encrypted data with the second substream of transencrypted data:
receiving from the control source a data stream corresponding to information on a global modification to be made to the data of the incoming stream,
encrypting these data by means of the homomorphic function,
making a linear combination between the stream of previously encrypted data corresponding to global modification information and the first substream or substreams of modified and encrypted data, or respectively and alternatively the second substream of transencrypted data, this linear combination of streams becoming the first substream or substreams of modified and encrypted data, or respectively and alternatively the second substream of transencrypted data, for making the subsequent combination constituting the stream of encrypted multimedia data sent as an output by the device.

6. A device adapted for receiving an incoming stream of encrypted multimedia data and sending an outgoing stream of encrypted multimedia data, the data in the outgoing stream corresponding to the data in the incoming stream after modification, wherein the device comprises circuitry configured for:
receiving a message coming from a control source, said message comprising information for identifying a separation of the incoming stream of encrypted multimedia data into at least one first encrypted data substream and one second encrypted data substream;
deciphering the encrypted data of the first substream or substreams identified,
modifying the deciphered data of the first substream or substreams identified, the modification being done using information received coming from the control source,
encrypting the modified data of the first substream or substreams, and
combining the first substream or substreams of modified and encrypted data with the second sub stream, so as to obtain the stream of encrypted multimedia data sent as an output by the device.

7. A computer program product embodied in a non-transitory computer readable medium, wherein the computer program product comprises instructions for the implementation, by a processor, of the method according to claim 1, when said instructions are executed by said processor.

8. A non-transitory computer readable storage media comprising a computer program product according to claim 7.
